(19) United States
(12) Patent Application Publication
(10) Pub. No.: US 2008/0046875 A1
(43) Pub. Date: Feb. 21, 2008

(54) Program Code Identification System and Method

(76) Inventors: Gad Haber, Nesher (IL); Andre Heilper, Haifa (IL); Marcel Zalmanovici, Kiryat Motzkin (IL)

Correspondence Address: Stephen C. Kaufman;IBM CORPORATION, Intellectual Property Law Dept., P.O. Box 218, Yorktown Heights, NY, 10598, US

(21) Appl. No.: 11/464,846

(22) Filed: Aug. 16, 2006

(51) Int. Cl. G06F 9/45

(52) U.S. Cl. 717/151

(57) ABSTRACT

A method for identifying a program code is provided. The method comprises identifying a plurality of basic blocks in a first program code, wherein the basic blocks are arranged in a first sequential order; rearranging the basic blocks in a second sequential order to generate a second program code; and using the second sequential order to generate a unique identification key associated with the first program code.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to identifying a program code and, more particularly, to a system and method for identifying a program code based on the order of the basic block within the program code.

### BACKGROUND

Software manufacturers use a variety of schemes to include an identification feature (i.e., watermark) in a program code. The watermark typically serves as a unique key that allows the manufacturer to determine whether a program code is a copy of another program code.

One method of watermarking a program code is to add the key (e.g., an alphanumeric character string) in the source or executable program code so that if the program is copied, one can trace the copy to the original. More sophisticated methods can scramble the key so it is not easily discoverable. Unfortunately, the current watermarking methods, even though sophisticated, can be discovered by a skilled person (i.e., hacker).

If a hacker can find the added key in the code, he can remove it. As a result, an illegal copy of an authentic program code no longer will include the watermark and cannot be traced to the original. Novel methods and systems are needed that can overcome the aforementioned shortcomings by eliminating the possibility for a hacker to find the particular key.

### SUMMARY

The present disclosure is directed to a system and corresponding methods that facilitate identifying a program code based on the order of the basic blocks in the code.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, a method for identifying a program code is provided. The method comprises identifying a plurality of basic blocks in a first program code, wherein the basic blocks are arranged in a first sequential order; rearranging the basic blocks in a second sequential order to generate a second program code; and using the second sequential order to generate a unique identification key associated with the first program code.

In one embodiment, the control flow among the basic blocks is adjusted so that second program code when executed generates same results as the first program code. The rearranging may comprise rearranging a subset of the basic blocks, wherein a basic block comprises a successive plurality of logic instructions having a single entry point or a single exit point.

The subset of the basic blocks may comprise at least a first basic block that is executed less frequently than a second basic block in the second program code, wherein the subset does not include the second basic block. In accordance with one embodiment, the subset of the basic blocks comprises N basic blocks, so that N! unique identification keys are generated to identify the first program code by rearranging the basic blocks in the second program code in N! unique sequences.

In another embodiment, the subset of the basic blocks comprises N basic blocks, so that the unique identification key is selected from a set of unique identification keys generated by rearranging the basic blocks in N! unique sequences.

Determining the unique identification key in the second sequential order may comprise comparing the second sequential order of the basic blocks in the second program code with a the first sequential order of basic blocks in the first program code; selecting the basic blocks that are out-of-order in the second sequential order, using the first sequential order as a reference; and constructing the unique identification key based on the selected out-of-order basic blocks.

In accordance with another aspect of the invention, a method for identifying a program code comprises identifying a plurality of basic blocks in the program code, wherein the basic blocks are arranged in a first sequential order; evaluating the first sequential order associated with the basic blocks in reference with a second sequential order of the basic blocks; and identifying a subset of the basic blocks that are not in same order in the first and second sequences.

In one embodiment, identifying the subset of the basic blocks comprises comparing order of the basic blocks in the first sequence with order of the basic blocks in the second sequence; and selecting the basic blocks from the first sequence that are not in same sequential position in the second basic block. It may be determined that the program code is an unauthorized copy, in response to determining that user of the program code is not the authorized user.

In another embodiment, a computer program product comprising a computer useable medium having a computer readable program is provide, wherein the computer readable program when executed on a computer causes the computer to divide a first program code into a plurality of basic blocks arranged in a first sequential order; rearrange the basic blocks in a second sequential order to generate a second program code; and use the second sequential order to generate a unique identification key associated with the first program code.

The computer readable program when executed on a computer further may cause the computer to adjust control flow among the basic blocks to so that second program code when executed generates same results as the first program code. The rearranging may comprise rearranging a subset of the basic blocks.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary block diagram of a program code comprising a plurality of basic blocks from which a unique identification key is generated, in accordance with one embodiment.

FIG. 2 is a flow diagram of a method for generating a unique identification key, in accordance with one embodiment.

FIG. 3 illustrates an exemplary block diagram of a program code comprising a plurality of basic blocks from which a unique identification key is extracted, in accordance with one embodiment.

FIG. 4 illustrates a flow diagram of a method of extracting a unique identification key from a program code, in accordance with one embodiment.

FIGS. 5A and 5B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF PREFERRED EMBODIMENTS

The present disclosure is directed to systems and corresponding methods that facilitate the identification of a program code based on the sequential arrangement of the program code's basic blocks.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

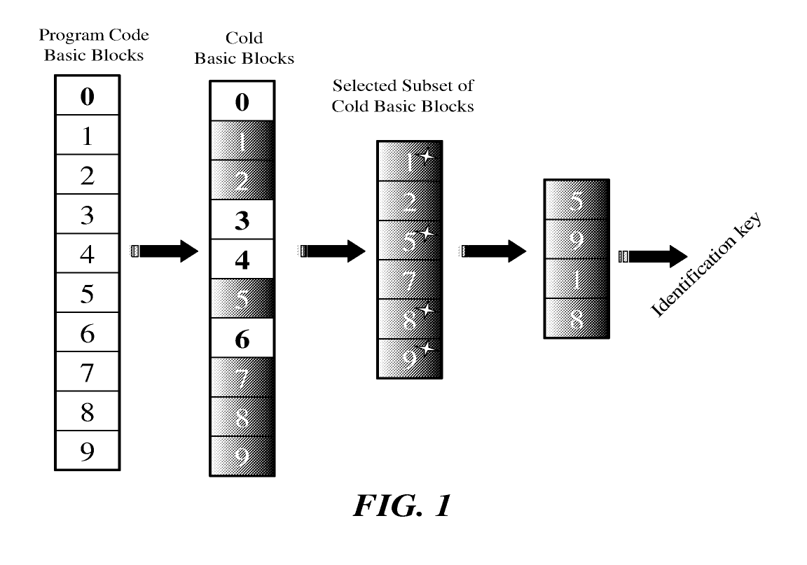

Referring to FIG. 1, a program code comprises a plurality of basic blocks (e.g., basic blocks 0 through 9). The program code, in accordance with one aspect of the invention, is a software application that is sold or is subject to a licensing agreement, for example, where the seller or the licensor is interested in identifying the program code and any copies of the program code to determine any breach of the sales or licensing agreement.

To identify the program code, a unique identifier is associated with the program code. In one embodiment, the unique identifier is constructed or detected based on the order in which the basic blocks are arranged in the program code. A basic block is a straight-line segment of logic code without any jumps in the middle. That is, each basic block comprises a sequence of instructions, where the instruction in each position dominates or executes before other instructions positioned in subsequent portions of the logic code, such that no other instruction executes between two instructions in a sequence. For example, referring back to FIG. 1, instructions in basic block 0 are performed prior to instructions in basic block 1, and so on.

To control the flow of execution between the basic blocks, branch instructions may be added at the end of each basic block. The blocks to which control may transfer after reaching the end of a block are that block's successors. The blocks from which control may have come when entering a block are that block's predecessors. Referring back to FIG. 1, for example, basic block 1 is a successor of basic block 0, and a predecessor to basic block 2, presuming that the control flow is from basic block 0 to basic block 1 to basic block 2, and so on.

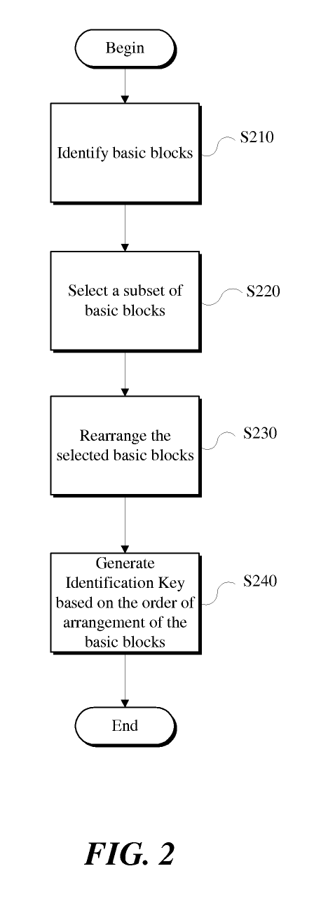

Referring to FIGS. 1 and 2, to uniquely identify a program code having basic blocks 0 through 9, for example, the program code's basic blocks are identified (S210). Hereafter, we refer to the program code which is the subject of the identification process as the original program code. In accordance with one embodiment, once the basic blocks of the original program code are identified, a subset of the basic blocks is selected (S220). As shown in FIG. 1, for example, a subset of basic blocks 0 through 9 may be represented by {1, 2, 5, 7, 8, 9}.

It is noteworthy that the number of the basic blocks in the selected subset need not be less than the number of the basic blocks in the original program code. In other words, the selected subset may, in certain embodiments, comprise all the basic blocks in the original program code (e.g., {0, 1, 2, 3, 4, 5, 6, 7, 8, 9}). The selected basic blocks are, preferably, the basic blocks that are not frequently executed. We refer to the less frequently executed basic blocks in the original program code as cold basic blocks, and to one or more other basic blocks that are more frequently executed as the main basic blocks, for example.

In accordance with one embodiment, the basic blocks in the original program code are rearranged to construct a copy of the original program code. We refer to the newly constructed copy of the original program code as the target program code. During the rearrangement process, preferably, the cold basic blocks in the original program code are rearranged in a different sequential order, while the sequential order of the main basic blocks remains unchanged. Advantageously, rearranging the cold basic blocks and maintaining the original order of the main basic blocks is likely to less adversely affect the execution efficiency of the target program code.

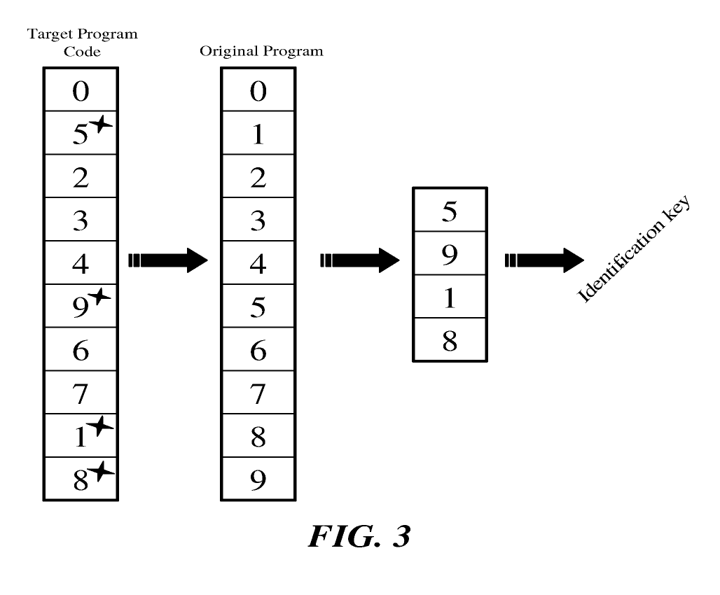

In some embodiments, the rearrangement enhances the execution efficiency of the target program code. It is noteworthy, however, that in alternative embodiments, the rearranging process is not limited to the cold basic blocks. Thus, in one or more embodiments, once a subset of the basic blocks is selected, the selected basic blocks are rearranged, regardless of the execution frequency (S230). As shown in FIG. 3, after the rearranging process, the sequential order of the basic blocks in the target program code is different from the sequential order of the basic blocks in the original program code.

The new sequential order in the target program code may be used to generate a unique identification key (S240). The unique identification key can be, for example, used to identify the target program code. If the original program code comprises N basic blocks, then N*(N-1)*(N-2)* . . . *3*2*1) or N! unique rearrangement of the original program code can be generated. That is, N! unique target program codes can be generated from the original program code. Since each arrangement is unique, N! unique identification keys can therefore be generated to identify N! target program codes for N! licensees or end users.

In other embodiments, other reordering schemes may be utilized to generate one or more unique identification keys. For example, in one embodiment, a derangement scheme may be used. A derangement is a permutation in which none of the members of a set or subset appear in their “natural” (i.e., ordered) place. For example, the derangements of {1 2, 3} are {2, 3, 1} and |{3, 1, 2}|, represented by |3=2|. The function giving the number of distinct derangements on n| elements is called the subfactorial |!n and is calculated as follows:

$$! n ≡ {\sum }_{k = 0}^{n} \frac{{( - 1 )}^{k}}{k !}$$

In yet other embodiments, additional unique identification keys may be generated by reordering a subset of the basic blocks in the original program code and randomly selecting M of the basic blocks to construct the unique identification key. For example, referring to FIG. 1, cold basic blocks {1, 2, 7, 8, 9} may be selected to form a subset of the original basic blocks {0, 1, 2, . . . , 9}. As noted above, the selected cold basic blocks in the subset can be rearranged to produce a unique identification key.

In yet another embodiment, a second subset of the cold basic blocks (e.g., {1, 5, 8, 9}) can be randomly selected from the subset {1, 2, 7, 8, 9} to construct a unique identification key. The sequential order of the randomly selected cold basic blocks may be rearranged to construct a unique identification key (e.g., {5, 9, 1, 8}), as shown in FIG. 1. In the exemplary embodiment disclosed here, the invention has been described as applicable to cold basic blocks. It is noteworthy, however, that instead of or in combination with the cold basic blocks, other basic blocks may be selected to construct a unique identification key.

In some embodiments, one or more optimization tools may be used for rearranging the order of the basic blocks as provided above. For example, an optimization tool configured for tuning the output of a compiler or maximizing the efficiency of an executable program may be used to rearrange the order of the basic blocks in the original program code. The following publications, the entire content of which is incorporated by reference herein, disclose exemplary optimization tools or methods that may be utilized to implement the rearrangement process disclosed here.

Nahshon and D. Bernstein, “FDPR—A Post-Pass Object Code Optimization Tool”, Proc. Poster Session of the International Conference on Compiler Construction, pp. 97-104, April 1996; G. Haber, E. A. Henis, and V. Eisenberg, “Reliable Post-link Optimizations Based on Partial Information” Proc. Feedback Directed and Dynamic Optimizations 3 Workshop, December 2000; E. A. Henis, G. Haber, M. Klausner and A. Warshavsky, “Feedback Based Post-link Optimization for Large Subsystems” Second Workshop on Feedback Directed Optimization, pp. 13-20, November 1999; R. Cohn, D. Goodwin, and P. G. Lowney, “Optimizing Alpha Executables on Windows NT with Spike”, Digital Technical Journal, vol. 9, no. 4, Digital Equipment Corporation 1997, pp. 3-20; T. Romer, G. Voelker, D. Lee, A. Wolman, W. Wong, H. Levy, B. Bershad and B. Chen, “Instrumentation and Optimization of Win32/Intel Executables Using Etch”, Proceedings of the USENIX Windows NT Workshop. August 1997, pp. 1-7.

In one embodiment, the above noted optimization tools or other control flow management tools may be used to add the needed control flows (e.g., branch instructions) to maintain the control transition between basic blocks as it is in the original program code. For example, referring to FIG. 3, if a target program code is rearranged as {0, 5, 2, 3, 4, 9, 6, 7, 1, 8} then branch instructions are added at the end of basic block 0 to switch the control flow from block 0 to 5, instead of from block 0 to 1, and so on.

Accordingly, when the target program is constructed, the target program will comprise the basic blocks of the original program code in a new sequence that is unique with reference to the initial order of the basic blocks in the original program code. Thus, if someone makes an unauthorized copy of the target program code, the unique position attributes associated with the plurality of basic blocks in the target program code are also transferred to the copy of the target program code.

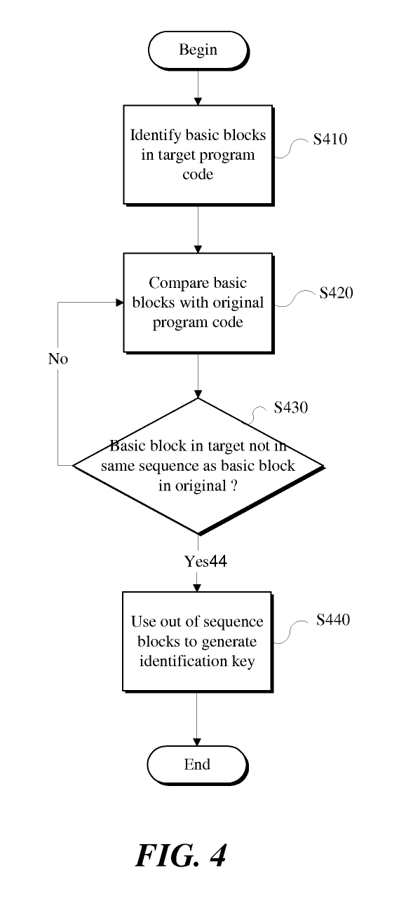

Referring to FIGS. 3 and 4, to extract the unique identification key from the target program code, the basic blocks in the target program code are identified (S410). The sequence of basic blocks in the exemplary target program code of FIG. 3 can be represented by {0, 5, 2, 3, 4, 9, 6, 7, 1, 8}. Once the basic blocks in the target program code are identified, the sequence of basic blocks in the target program code is compared with the sequence in the original program code (S420). In one embodiment, it is determined whether each basic block in the target program code is in the same sequence as the comparable basic block in the original program code (S430).

For example, as shown in FIG. 3, basic blocks {5, 9, 1, 8} are out of sequence when the exemplary target program code and the original program code are compared. Thus, in accordance with one embodiment, the out of sequence basic blocks are used to generate the unique identification key (S440). Once the unique identification key is extracted, it may be cross-referenced with a list of identification keys for the purpose of determining whether the target program code is a legitimate or illegitimate copy. An illegitimate copy may be an illegally reproduced copy of the program code or an expired version of the program code that may have to be updated.

In some embodiments, if the copy is determined to be illegitimate, then the legitimate owner of the target program code may be determined by mapping the unique identification key to the entity to which the unique identification key was issued or assigned. In this manner, the source of an illegitimate copy can be identified and further action may be taken to determine how to respond to the unauthorized copying of the program code.

The advantage of using different permutations of basic blocks in a program code to generate a corresponding unique identification key is that a hacker, by looking at the target program code, will be unable to determine whether the basic blocks have been rearranged. Therefore, unless the hacker knows the sequential arrangement of the basic blocks in the original program code, he won't be able to determine how the basic blocks in the target program code have been rearranged, and therefore cannot extract or remove the unique identification key.

Thus, the rearrangement of the basic blocks creates a watermark for the program code that is invisible to the hacker without the knowledge of the original order of the basic blocks. As such, in contrast to other watermarking methods that embed a specific character string in the program code as the identification key, a hacker will be unable to search for an embedded identification key. Since, it is nearly impossible for an outsider to know the original order of the basic blocks, finding the unique identification key, or rearranging the basic blocks to their initial state would be very difficult.

In different embodiments, the invention can be implemented either entirely in the form of hardware or entirely in the form of software, or a combination of both hardware and software elements. For example, one or more computing systems in conjunction with one or more software environments may be used to identify and rearrange the basic blocks in a program code or construct and extract the unique identification key. The computing systems and software environments may comprise a controlled computing system environment that can be presented largely in terms of hardware components and software code executed to perform processes that achieve the results contemplated by the system of the present invention.

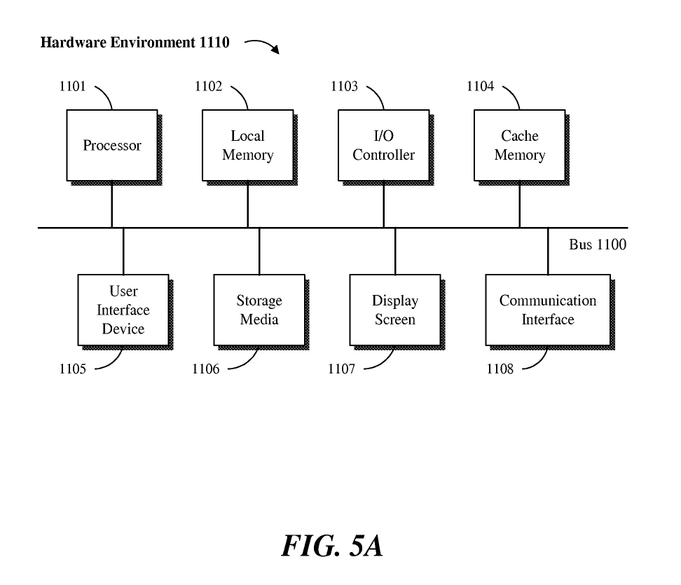

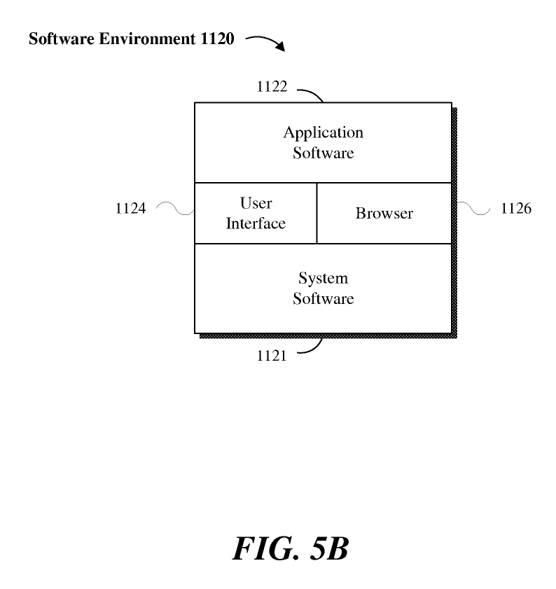

Referring to FIGS. 5A and 5B, a computing system environment in accordance with an exemplary embodiment is composed of a hardware environment 1110 and a software environment 1120. The hardware environment 1110 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. System software 1121 comprises control programs, such as the operating system (OS) and information management systems that instruct the hardware how to function and process information.

In a preferred embodiment, a software application is implemented as application software 1122 executed on one or more hardware environments to rearrange the basic blocks of an original program code to generate a target program code and a unique key from the rearranged basic blocks or to extract a unique key from the rearranged basic blocks. Application software 1122 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-RW) and digital video disk (DVD).

Referring to FIG. 5A, an embodiment of the application software 1122 can be implemented as computer software in the form of computer readable code executed on a data processing system such as hardware environment 1110 that comprises a processor 1101 coupled to one or more memory elements by way of a system bus 1100. The memory elements, for example, can comprise local memory 1102, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 5B, application software 1122 can comprise one or more computer programs that are executed on top of system software 1121 after being loaded from storage media 1106 into local memory 1102. In a client-server architecture, application software 1122 may comprise client software and server software. For example, in one embodiment of the invention, client software is executed on computing system 100 and server software is executed on a server system (not shown).

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention and are further defined by the claims and their full scope of equivalents.

What is claimed is:

1. A method for identifying a program code, the method comprising:
identifying a plurality of basic blocks in a first program code, wherein the basic blocks are arranged in a first sequential order;
rearranging the basic blocks in a second sequential order to generate a second program code; and
using the second sequential order to generate a unique identification key associated with the first program code.

2. The method of claim 1, further comprising adjusting control flow among the basic blocks so that second program code when executed generates same results as the first program code.

3. The method of claim 1, wherein the rearranging comprises rearranging a subset of the basic blocks.

4. The method of claim 3, wherein the subset of the basic blocks comprises at least a first basic block that is executed less frequently than a second basic block in the second program code, wherein the subset does not include the second basic block.

5. The method of claim 1, wherein a basic block comprises a successive plurality of logic instructions having a single entry point.

6. The method of claim 1, wherein a basic block comprises a successive plurality of logic instructions having a single exit point.

7. The method of claim 3, wherein the subset of the basic blocks comprises N basic blocks, so that N! unique identification keys are generated to identify the first program code by rearranging the basic blocks in the second program code in N! unique sequences.

8. The method of claim 3, wherein the subset of the basic blocks comprises N basic blocks, so that the unique identification key is selected from a set of unique identification keys generated by rearranging the basic blocks in N! unique sequences.

9. The method of claim 1, further comprising assigning the unique identification key to an authorized user.

10. The method of claim 9, further comprising determining the unique identification key in the second sequential order by:
comparing the second sequential order of the basic blocks in the second program code with a the first sequential order of basic blocks in the first program code;
selecting the basic blocks that are out of order in the second sequential order, using the first sequential order as a reference; and
constructing the unique identification key based on the selected out of order basic blocks.

11. A method for identifying a program code, the method comprising:
identifying a plurality of basic blocks in the program code, wherein the basic blocks are arranged in a first sequential order;
evaluating the first sequential order associated with the basic blocks in reference with a second sequential order of the basic blocks; and
identifying a subset of the basic blocks that are not in same order in the first and second sequences.

12. The method of claim 11, wherein identifying the subset of the basic blocks comprises:
comparing order of the basic blocks in the first sequence with order of the basic blocks in the second sequence; and
selecting the basic blocks from the first sequence that are not in same sequential position in the second basic block.

13. The method of claim 11, wherein the subset of the basic blocks comprises a unique identification key for the program code.

14. The method of claim 13, further comprising identifying an authorized user of the program code based on the unique identification key.

15. The method of claim 14, further comprising determining that the program code is an unauthorized copy, in response to determining that user of the program code is not the authorized user.

18. A computer program product comprising a computer useable medium having a computer readable program, wherein the computer readable program when executed on a computer causes the computer to:
divide a first program code into a plurality of basic blocks arranged in a first sequential order;
rearrange the basic blocks in a second sequential order to generate a second program code; and
use the second sequential order to generate a unique identification key associated with the first program code.

19. The computer program product of claim 18, wherein the computer readable program when executed on a computer further causes the computer to adjust control flow among the basic blocks to so that second program code when executed generates same results as the first program code.

20. The computer program product of claim 18, wherein the rearranging comprises rearranging a subset of the basic blocks.
